(19) United States
(12) Patent Application Publication
(10) Pub. No.: US 2025/0342777 A1
(43) Pub. Date: Nov. 6, 2025

(54) COMPUTER SYSTEM AND METHOD FOR COGNITIVE TESTS FOR SCALABLE PRECISION EDUCATION

(71) Applicant: ACUITY INSIGHTS INC., Toronto (CA)

(72) Inventors: Cole WALSH, Toronto (CA); Alexander MACINTOSH, Toronto (CA); Harold REITER, Toronto (CA)

(21) Appl. No.: 19/197,072

(22) Filed: May 2, 2025

Related U.S. Application Data
(60) Provisional application No. 63/641,998, filed on May 3, 2024.

(51) Int. Cl. G09B 7/00; G06F 40/279; G06F 40/40

(52) U.S. Cl. CPC G09B 7/00; G06F 40/279; G06F 40/40

(57) ABSTRACT

Embodiments described herein relate to computer systems and methods for cognitive tests for scalable precision education that involves artificial intelligence, natural language processing, machine learning, large language models, model training, and scalable distributed computing infrastructure. Embodiments described herein relate to computer systems for cognitive tests for scalable precision education for a user. The system can classify and extract skill items and knowledge items from the one or more databanks of items based on categorization confidence scores generated by tuned large language models. The system can use conversation agents enabled by the one or more large language models for customized prompting based on user history records and user evaluations in skill and knowledge. The system generates a prescribed curriculum customized for users.

### FIELD

The improvements generally relate to the field of computer systems, artificial intelligence, natural language processing, machine learning, large language models, model training, and scalable education systems.

### INTRODUCTION

Traditional educational systems often struggle to provide personalized learning experiences due to the sheer volume of students and the variability in their learning needs. While standardized tests offer a means of objective assessment, the tests can be time-consuming and may not accurately reflect a student's abilities.

A student's overall cognitive abilities and preparedness in a particular subject matter are distinct attributes but are often intertwined. Depending on the situation, an independent assessment of abilities or preparedness may be beneficial. However, there is a lack of development and implementation of a scalable and affordable process of up-levelling able but unprepared students because they remain unidentifiable in the absence of broad-scale cognitive ability tests.

Embodiments described herein relate to a distributed computer hardware environment to support scalable precision education. Distributed systems pose technical challenges for testing integrity. It is desirable to provide more efficient and precise assessments, dynamically adjusting to the student's performance, and scalable for mass adoption. Embodiments described herein provide secure, efficient and accurate systems. Network traffic can result in congestion which may impact scalability of the distributed system.

### SUMMARY

In an aspect, there is provided a computer system for cognitive tests for scalable precision education for a user. The system comprises: a memory storing one or more large language models, user history records, and one or more databanks of items; and a computer hardware processor coupled with computer memory, a non-transitory computer readable storage medium, and an applicant interface residing on an electronic device.

In some embodiments, the computer processor is configured to: tune the one or more large language models for knowledge and skill classification and extraction using a dataset of labeled examples, wherein each labeled example has a corresponding classification label; classify and extract skill items and knowledge items from the one or more databanks of items based on categorization confidence scores generated by the tuned one or more large language models; administer a cognitive test, at the applicant interface residing on the electronic device, using the skill items and knowledge items, the cognitive test producing a set of resulting scores indicating a user evaluation in skill and knowledge, respectively; generate, by a conversation agent enabled by the one or more large language models, a customized prompting based on the user history records and the user evaluation in skill and knowledge; receive, by the conversation agent, user response data, the conversation agent classifying the user response data to identify recommended skills and knowledge for development; and generate a prescribed curriculum customized for the user based at least on the recommended skills and knowledge for development, and transmit the prescribed curriculum for the user to the applicant interface residing on the electronic device, the prescribed curriculum being a reduced data size for efficient storage and transmission while providing effective skills and knowledge development for the user.

In some embodiments, the conversation agent is fine-tuned using the recommended skills and knowledge for development, the conversation agent fine-tuned to generate a future customized prompting based on a pattern recognized between the user and the recommended skills and knowledge for development.

In some embodiments, the one or more large language models query development resource databases using query codes converted from natural language corresponding to the recommended skills and knowledge for development, the one or more large language models receiving a development resource or a combination of development resources to generate the prescribed curriculum for the user.

In some embodiments, the prescribed curriculum comprises a selection of: online courses, reading materials, practice exercises, and individual lessons.

In some embodiments, the one or more databanks of items comprise labeled items with assigned categories and unlabeled items, wherein the processor tunes the one or more large language models with the labeled items with assigned categories, automatically categorizes the unlabeled items using the tuned one or more large language models, and outputs item categorizations generated by the tuned one or more large language models.

In some embodiments, if the categorization confidence scores are below a predetermined threshold, the processor generates an alert requesting a human review and generates a subset of data of one or more questions and corresponding responses for transmission to a reviewer or rater interface.

In some embodiments, the processor transmits the skill items and knowledge items to a reviewer interface for manual labeling and feedback, and tunes the one or more large language models using the feedback.

In some embodiments, the processor automatically assigns one or more categories to each item of at least a portion of the items using the tuned one or more large language models, wherein the process generates an alert when an item cannot be automatically categorized.

In some embodiments, the processor automatically categorizes learning resources using the one or more large language models.

In some embodiments, the processor provides the conversation agent to provide a recommendation to a user about resources to address particular knowledge or skills for development and justifications on how the recommendation was generated.

In some embodiments, the processor tunes the one or more large language models to categorize at least a portion of items based on what knowledge or skill a respective item is assessing.

In some embodiments, the system has a client web application with a curriculum interface to provide the prescribed curriculum.

In some embodiments, the system has a client web application with a reviewer interface to display alerts for categorizations and receive feedback, wherein the processor tunes the one or more large language models based on the feedback.

In some embodiments, the system has a client web application with an applicant interface to provide a computer adaptive test to collect response data for each user, wherein the memory comprises a user history record storing the collected response data and corresponding evaluation data.

In some embodiments, the system has a client web application with a rater interface that provides response data for a computer adaptive test and collects corresponding evaluation data for the response data for the computer adaptive test.

In some embodiments, the computer processor is configured to tune the one or more large language models for knowledge and skill classification and extraction using a dataset of labeled knowledge examples and another data set of skill examples.

In some embodiments, the categorization confidence scores generated by the one or more large language models comprise numerical values that represent the level of certainty the one or more large language models have in its predictions or classifications for a given input data point.

In some embodiments, the prescribed curriculum is specific to a user and different from prescribed curriculums for other users, wherein the prescribed curriculum is an education plan, a set of courses and educational content for the user.

In another aspect, there is provided a computer method for cognitive tests for scalable precision education. The method involves: tuning the one or more large language models for knowledge and skill classification and extraction using labeled examples; classifying and extracting skill items and knowledge items from the one or more databanks of items based on categorization confidence scores generated by the one or more large language models; administering a cognitive test, at the applicant interface, using the skill items and knowledge items, the cognitive test producing a set of resulting scores indicating a user evaluation in skill and knowledge, respectively; generating, by a conversation agent enabled by the one or more large language models, a customized prompting based on the user history records and the user evaluation in skill and knowledge; receiving, by the conversation agent, user response data, the conversation agent classifying the user response data to identify recommended skills and knowledge for development; and generating and outputting at the applicant interface, a prescribed curriculum for the user based at least on the recommended skills and knowledge for development.

In another aspect, there is provided a non-transitory computer readable medium storing computer interpretable instructions, which when executed by a processor, cause the processor to execute a method for cognitive tests for scalable precision education, the method comprising: tuning the one or more large language models for knowledge and skill classification and extraction using labeled examples; classifying and extracting skill items and knowledge items from the one or more databanks of items based on categorization confidence scores generated by the one or more large language models; administering a cognitive test, at the applicant interface, using the skill items and knowledge items, the cognitive test producing a set of resulting scores indicating a user evaluation in skill and knowledge, respectively; generating, by a conversation agent enabled by the one or more large language models, a customized prompting based on the user history records and the user evaluation in skill and knowledge; receiving, by the conversation agent, user response data, the conversation agent classifying the user response data to identify recommended skills and knowledge for development; and generating and outputting at the applicant interface, a prescribed curriculum for the user based at least on the recommended skills and knowledge for development.

In accordance with an aspect, there is provided a computer system for cognitive tests for scalable precision education. The system has a memory storing one or more large language models, user history records, and one or more databanks of items; and a hardware processor coupled to the memory programmed with executable instructions for model tuning and validation. The processor: tunes the one or more large language models for knowledge and skills identification and extraction; provides customized prompting based on the user history record to receive feedback data for tuning the one or more large language models; provides a conversation agent using the one or more large language models to identify skills and knowledge for development and resource recommendations; and generates and outputs a prescribed curriculum for a user.

In some embodiments, the one or more databanks of items comprise labeled items with assigned categories and unlabeled items, wherein the processor tunes the one or more large language models with the labeled items assigned categories, automatically categorizes the unlabeled items using the tuned one or more large language models, and outputs item categorizations generated by the tuned one or more large language models.

In some embodiments, the processor tunes the one or more large language models to categorize at least a portion of the items as being knowledge-based or skill-based.

In some embodiments, the processor automatically assigns one or more categories to each item of at least a portion of the items using the tuned one or more large language models, wherein the process generates an alert when an item cannot be automatically categorized.

In some embodiments, the processor generates a suggested category for an item using the one or more large language models, transmits the suggested category for the item to a reviewer interface for approval and feedback, and tunes the one or more large language models using the feedback.

In some embodiments, the processor automatically categorizes learning resources using the one or more large language models.

In some embodiments, the processor provides the conversation agent to provide a recommendation to a user about resources to address particular knowledge or skills for development and details about how the recommendation was generated.

In some embodiments, the processor tunes the one or more large language models to categorize at least a portion of items based on what knowledge or skill a respective item is assessing.

In some embodiments, the system has a client web application with a curriculum interface to provide the prescribed curriculum.

In some embodiments, the system has a client web application with a reviewer interface to display alerts for categorizations and receive feedback, wherein the processor tunes the one or more large language models based on the feedback.

In some embodiments, the system has a client web application with an applicant interface to provide a computer adaptive test to collect response data for each user, wherein the memory comprises a user history record storing the collected response data and corresponding evaluation data.

In some embodiments, the system has a client web application with a rater interface that provides response data for a computer adaptive test and collects corresponding evaluation data for the response data for the computer adaptive test.

In accordance with an aspect, there is provided a computer method for cognitive tests for scalable precision education. The method involves: tuning one or more large language models for knowledge and skills identification and extraction; automatically categorizing new items with the tuned one or more large language models; transmitting alerts for categorizations and receiving feedback; tuning the one or more large language models using the feedback; outputting or storing item and level categorizations generated by the one or more large language models; continuously tuning the one or more large language models using the item and level categorizations and additional feedback; and generating and delivering a prescribed curriculum using the tuned one or more large language models.

Many further features and combinations thereof concerning embodiments described herein will appear to those skilled in the art following a reading of the instant disclosure.

### DESCRIPTION OF THE FIGURES

In the figures,

FIG. 1 is a view of an example system for scalable precision education;

FIG. 2 is a diagram of an example process flow for test administration and customized model tuning and validation;

FIG. 3 is a view of an example of process model tuning and validation;

FIG. 4. shows a flow diagram of a process for customized LLM prompting for each user;

FIG. 5. shows a flow diagram of a process for a conversation agent to identify knowledge and skills for development, and recommended resources; and

FIG. 6 shows a diagram of an electronic device that can be used for operations of the system in some embodiments.

### DETAILED DESCRIPTION

Embodiments described herein relate to computer systems and methods for cognitive tests for scalable precision education that involve artificial intelligence, natural language processing, machine learning, large language models, model training, and scalable distributed computing infrastructure.

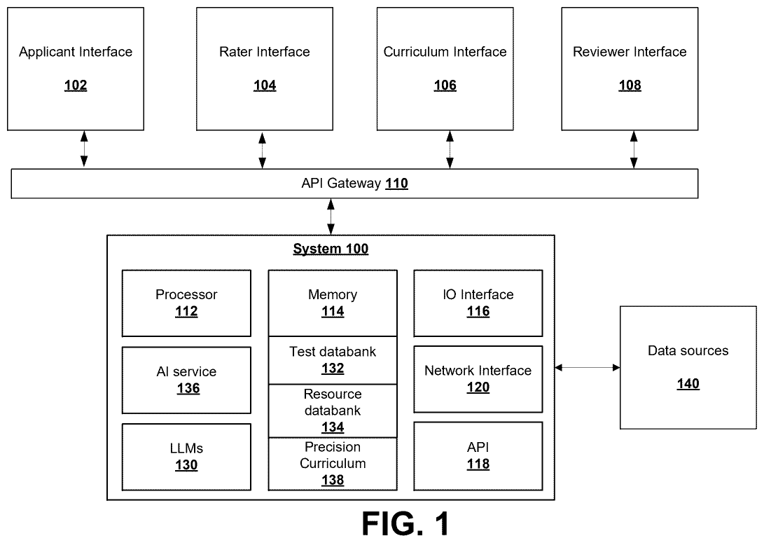

Embodiments described herein relate to the field of distributed computer systems for cognitive testing. FIG. 1 shows an example system 100 for precision education.

System 100 provides a distributed computer hardware environment to support cognitive testing (including, for example, standardized cognitive testing) for prescribing scalable precision education. System 100 provides a distributed computer hardware environment to support onsite testing and offsite testing, for example. The prescribed precision education can be used for different applications: students admitted into educational programs may require preparation prior to starting at an education institution; and admitted students may require preparation that involves improving their skills and knowledge of certain categories to be sufficiently prepared for an educational program. The process of improving a student's skills and knowledge of certain categories can be applied through a standard curricular delivery that includes preparatory materials for students. However, there exists a need for a scalable system. There exists a need for customized curriculums with customizations for each individual user.

Embodiments described herein provide a system 100 that is scalable and can prescribe precision education customized to each user. An example user is a student user.

System 100 has different components to perform different operations to create a prescribed curriculum. In some embodiments, system 100 can create and validate tests of cognitive ability and/or achievement. Cognitive ability can involve processes involved in acquiring knowledge and understanding. These abilities can include memory, attention, problem-solving skills, language abilities, reasoning, perception, and other processes of interpreting sensory data and information. Achievement, on the other hand, refers to the accomplishments or proficiency in specific areas, often measured through tests or assessments. Achievement is typically the result of applying cognitive abilities to learn and master particular skills or knowledge. For example, academic achievement might be measured by grades or standardized test scores, reflecting how well a person has learned and applied their cognitive abilities in educational settings. For example, a test can be directed to cognitive ability instead of achievement.

In some embodiments, system 100 can utilize and extract questions or items from cognitive test databanks 132 to create tests of cognitive ability. In some embodiments, system 100 can perform computer adaptive testing (CAT) by administering tests of cognitive ability that are dynamically adjusted based on the test-taker and the test-taker's performance. That is, system 100 can generate different tests that are adapted to different users. System 100 can create individualized student prescriptions of precision education by utilizing an artificial intelligence (AI) service 136 with machine learning tools, such as large language models (LLMs) 130. In some embodiments, system 100 can access large-scale curricular databases (e.g. data sources) 140. Example curricular databases can include educational resources, syllabi, course materials, and other academic content used to support and enhance learning across various educational institutions.

System 100 provides a distributed computer system for online CAT testing with multiple client web applications and interfaces (e.g. an applicant interface 102, a rater interface 104, a curriculum interface 106, and a reviewer interface 108). System 100 provides application services and communications with the different interfaces using an application programming interface (API) gateway 110. The API gateway 110 transmits messages and exchanges data between the client web applications or interfaces and the application services.

The applicant interface 102 is configured to provide an online exam for an applicant and collect response data for the online exam. An exam service and the exam application programming interface service compile the online exam for the applicant, the online exam comprising a test of a collection of scenarios with at least a subset of scenarios being audiovisual response scenarios. The system 100 can have a content application programming interface service and a content service that delivers content for the exam. The rater interface 104 is configured to provide response data for the exam and collects rating data for the response data for the exam. The rater interface 104 is configured to compute a rating for the exam using the rating data. The rater interface 104 can be configured for human rating in some embodiments. This rating data set can be used by system 100 for comparison to automated ratings, for example. The rater interface 104 can be configured to display the question asked for the exam and the applicant's response for efficient and accurate capture of rating data. The rater interface 104 can also display human-specific scoring guidelines. The rater interface 104 can provide an area to input one or more scores, which may take the form of a checkbox (i.e., binary), “select one”, “select many”, or a Likert scale, for example. The rater interface 104 can also provide text boxes to add additional comments associated with each of the rater scores. The curriculum interface 106 is configured to enable a user to access curriculums generated and delivered by system 100. The reviewer interface 108 is configured to provide feedback and input to the AI service 136 for tuning and validating LLMs 130, for example. Further details regarding model tuning and validation is provided herein.

In some embodiments, system 100 is used for prognosis. In some embodiments, system 100 provides cognitive tests of ability rather than achievement and replaces tests of achievement. For prognosis, the same or a parallel form of testing can be given to all students in the event that a preset threshold (e.g., school admission) is based upon the results of the online testing in process 200. System 100 can provide investigation tools using cognitive test databanks 132, which contains large numbers of questions available to detect areas of unpreparedness. System 100 can use CAT to more rapidly narrow down areas of unpreparedness by adaptively changing the test questions delivered based on previously answered questions. For example, a test-taker that has answered several questions in each curricular area will not need to answer more questions in areas in which they are performing well to confirm preparedness. System 100 can generate curriculums and adaptively change the test questions to have more questions focus within areas of poorer performance and to narrow down those areas of concern as much as possible such that each test becomes individualized to the specific test-taker and their areas of greatest unpreparedness. Process 200 utilizes machine learning tools to provide a prescription for precision education. System 100 provides generation and delivery of the prescribed curriculum utilizing machine learning and artificial intelligence processes, and various data sets or data sources, such as massive open online courses (MOOCs) or other curricular tools.

In some embodiments, system 100 can use CAT, which can alter the questions from test databanks 132 adaptively during the test, individualizing the test to the user to quickly identify the gaps each user has regarding the curriculum and room for mastery improvement. Using CAT for testing can provide more dynamism, efficiency and precision to measure a user's knowledge and skills.

For simplicity, only one set of example interfaces 102, 104, 106, and 108 are shown but system 100 may connect to multiple interfaces beyond 102, 104, 106, and 108 to provide a scalable solution to accommodate a large number of users. The interfaces 102, 104, 106, 108 can be at computing devices operable by users to access remote network resources and downstream systems to exchange data. System 100 can detect capabilities of computing devices (used for interfaces 102, 104, 106, and 108) and adjust interfaces 102, 104, 106, and 108 to accommodate the different capabilities. The computing devices may be the same or different types of devices. The computing device includes at least one processor, a data storage device (including volatile memory or non-volatile memory or other data storage elements or a combination thereof), and at least one communication interface. The computing device components may be connected to system 100 in various ways including directly coupled, indirectly coupled via a network, and distributed over a wide geographic area and connected to system 100 via a network (which may be referred to as “cloud computing”).

System 100 includes at least one processor 112, memory 114, at least one I/O interface 116, and at least one network interface 120. System 100 also includes AI service 136 for tuning and validating LLMs 130. System 100 can have test databanks 132 and resource databanks 134. System 100 can generate precision curriculum 138 for transmission, storage, display, and so on. System 100 can also access different data sources 140 for extracting items and questions, for example.

Each processor 112 may be, for example, a combination of microprocessors and microcontrollers configured to support the services and interfaces within system 100. Memory 114 may include a suitable combination of computer memory that is located either internally or externally. Each I/O interface 116 can be specifically configured to enable system 100 to interconnect with different data sources 140, and to connect with other types of devices such as one or more input devices, such as a keyboard, mouse, camera, touch screen and microphone, or with one or more output devices such as a display screen and a speaker. Each network interface 120 enables system 100 to communicate with other components, to exchange data with other components, to access and connect to network resources, to serve applications, and to perform other computing applications by connecting to a network (or multiple networks) capable of carrying data.

System 100 is operable to register and authenticate users (using a login, unique identifier, and password for example) prior to providing access to interfaces, applications, a local network, network resources, other networks and network security devices. System 100 may serve multiple users.

Accordingly, system 100 provides a secure computer system for cognitive tests for scalable precision education for a user. System 100 has one or more memories 114 storing one or more large language models, user history records, one or more databanks of items, and different customized curriculums for different users. System 100 has one or more hardware processors 112 coupled with the computer memory 114, and a non-transitory computer readable storage medium or instructions. System 100 has a secure API gateway 110 to different interfaces including an applicant interface 102 residing on an electronic device.

In some embodiments, the computer processor 112 is configured to: tune the one or more large language models 130 for knowledge and skill classification and extraction using a dataset of labeled examples, wherein each labeled example has a corresponding classification label. In some embodiments, the computer processor 112 is configured to: classify and extract skill items and knowledge items from the one or more databanks of items based on categorization confidence scores generated by the tuned one or more large language models. In some embodiments, the one or more databanks of items comprise labeled items with assigned categories and unlabeled items. The processor 112 tunes the one or more large language models 130 with the labeled items with assigned categories, automatically categorizes the unlabeled items using the tuned one or more large language models, and outputs item categorizations generated by the tuned one or more large language models.

In some embodiments, the computer processor 112 is configured to: administer a cognitive test, at the applicant interface residing on the electronic device, using the skill items and knowledge items. The cognitive test produces a set of resulting scores indicating a user evaluation in skill and knowledge, respectively. System 100 receives and processes the resulting scores. In some embodiments, the computer processor 112 is configured to: generate, by a conversation agent (e.g. AI service 136) enabled by the one or more large language models 130, a customized prompting based on the user history records and the user evaluation in skill and knowledge. The conversation agent (and system 100) receives user response data, and classifies the user response data to identify recommended skills and knowledge for development. System then generates a prescribed curriculum customized for the user based at least on the recommended skills and knowledge for development, and transmit the prescribed curriculum for the user to the applicant interface residing on the electronic device. The prescribed curriculum being a reduced data size for efficient storage and transmission while providing effective skills and knowledge development for the user. In some embodiments, the prescribed curriculum comprises a selection of: online courses, reading materials, practice exercises, and individual lessons. In some embodiments, the system connects to a client web application with a curriculum interface 106 to provide the prescribed curriculum via secure API gateway 110. In some embodiments, the prescribed curriculum is specific to a user and different from prescribed curriculums for other users, wherein the prescribed curriculum is an education plan, a set of courses and educational content for the user.

In some embodiments, the conversation agent is fine-tuned using the recommended skills and knowledge for development, the conversation agent fine-tuned to generate a future customized prompting based on a pattern recognized between the user and the recommended skills and knowledge for development.

In some embodiments, the one or more large language models 130 query development resource databases using query codes converted from natural language corresponding to the recommended skills and knowledge for development, the one or more large language models receiving a development resource or a combination of development resources to generate the prescribed curriculum for the user.

In some embodiments, the categorization confidence scores generated by the one or more large language models comprise numerical values that represent the level of certainty the one or more large language models have in its predictions or classifications for a given input data point. In some embodiments, if the categorization confidence scores are below a predetermined threshold, the processor generates an alert requesting a human review and generates a subset of data of one or more questions and corresponding responses for transmission to a reviewer or rater interface.

In some embodiments, the processor transmits the skill items and knowledge items to a reviewer interface for manual labeling and feedback, and tunes the one or more large language models using the feedback.

In some embodiments, the processor automatically assigns one or more categories to each item of at least a portion of the items using the tuned one or more large language models, wherein the process generates an alert when an item cannot be automatically categorized.

In some embodiments, the processor automatically categorizes learning resources using the one or more large language models.

In some embodiments, the processor provides the conversation agent to provide a recommendation to a user about resources to address particular knowledge or skills for development and justifications on how the recommendation was generated.

In some embodiments, the processor tunes the one or more large language models to categorize at least a portion of items based on what knowledge or skill a respective item is assessing.

In some embodiments, the system has a client web application with a reviewer interface 104 to display alerts for categorizations and receive feedback. The processor 112 can tune the one or more large language models based on the feedback.

In some embodiments, the system has a client web application with an applicant interface 102 to provide a computer adaptive test to collect response data for each user. The memory 114 can store a user history record storing the collected response data and corresponding evaluation data.

In some embodiments, the system has a client web application with a rater interface that provides response data for a computer adaptive test and collects corresponding evaluation data for the response data for the computer adaptive test.

The web applications with improved interfaces may reside on hardware that is not part of secure system 100 which may raise technical challenges for security and testing integrity. Further, there may be numerous web applications with improved interfaces which raises technical challenges for scalability. Embodiments can provide a system 100 with improvements for scalability and security. The prescribed curriculum is customized for a user which may improve usage of networking resources by only transmitting a specific set of testing items. This can improve latency and congestion, for example, particularly when there are a large number of web applications accessing system 100. System 100 generates useful output for transmission in a protected format to improve data integrity and security. System 100 improves the use of resources while providing customized curriculum to improve online learning. System 100 can reduce network load while still providing meaningful testing and evaluations.

In some embodiments, the computer processor is configured to tune the one or more large language models for knowledge and skill classification and extraction using a dataset of labeled knowledge examples and another data set of skill examples.

System 100 can include multiple web applications (with different interfaces), and exchange and generate data for these multiple web applications and interfaces. This requires efficient use of resources to support scalability.

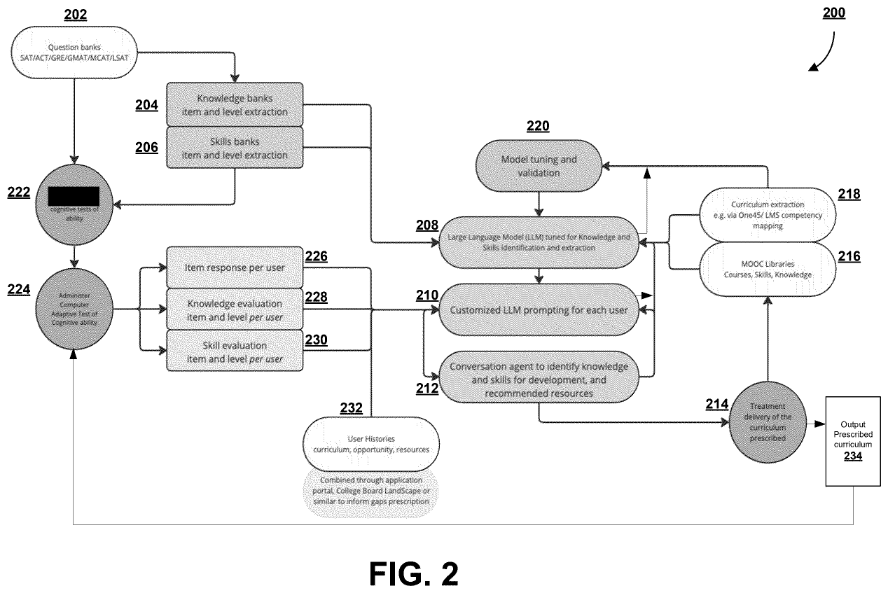

Referring now to FIG. 2, there is shown a flow diagram of an example process 200 for test administration and customized model tuning and validation.

Process 200 can be scalable to serve multiple devices for multiple users. Process 200 can generate and output a prescribed curriculum at 234 to provide precision education customized to each user. An example user is a student user.

The process 200 involves using components of system 100 to perform different operations to create a prescribed curriculum/precision curriculum 138. A prescribed curriculum 138 can refer to a customized set of courses, lessons, and content tailored to meet the individual needs and goals of each user. The individualized precision curriculum 138 can be designed based on a user's goals and measured skill or knowledge gaps. For example, the prescribed curriculum can include specific learning objectives, recommended materials and resources, and formative assessment methods to evaluate progress. Process 200 utilizes machine learning tools provided by artificial intelligence (AI) service 136 to generate prescribed curriculum 138 for precision education. System 100 provides generation and delivery of the prescribed curriculum 138 utilizing machine learning and AI service 136, and various data sets or data sources, such as MOOCs or other curricular tools. For example, at 234, system 100 can output the prescribed curriculum 138 for transmission, storage, display, and so on. For example, system 100 can transmit the prescribed curriculum 138 to a user device for display to provide precision education tailored to a specific user connected to the user device (e.g. by a user account).

At 202, system 100 receives, accesses and/or stores test databanks 132 and/or resource databanks 134 that contain a large numbers of questions or items that cover one or more curriculum. System 100 process pulls and/or extracts questions or items from the cognitive test databanks 132 and/or resource databanks 134 to form tests, such as cognitive tests of ability. For example, the test questions can be pulled from standardized test data sources such as SATs, ACTs, GRES, GMATs, MCATs, and LSATs.

At 204 and 206, system 100 can process, extract and/or categorize questions or items into knowledge banks and skill banks, respectively. In some embodiments, the knowledge banks and skill banks form part of test databanks 132 and/or resource databanks 134, which can be further supplemented by external data sources 140. A skill can refer to an ability to do a course, program, activity, job, expertise, talent, aptitude, and so on. Knowledge can refer to knowing something with familiarity gained through experience, range of an individual's information or understanding, knowing information, familiarity with content, and so on. A skill may be independent of content knowledge. System 100 can train on the cognitive test databanks 132 and/or resource databanks 134 to fine-tune and categorize the items or questions for the knowledge databanks (at 204) and skills databanks (at 206). That is, system 100 can organize items and questions for the knowledge databanks (at 204) and skills databanks (at 206) by categorizing or labelling the items and questions as relating to knowledge and/or skills.

That is, system 100 is configured to classify and extract skill items and knowledge items from the one or more databanks of items based on categorization confidence scores generated by the one or more large language models. Classify can refer to the process of system 100 assigning a category or label to a given item based on its content. This is an example task in natural language processing (NLP).

System 100 can implement item and level extraction from the databanks at 204 and 206 (e.g. data stores) to generate test(s) at 222. An item can refer to a question for a test to assess specific knowledge or skill. A level can refer to a skill level or a level of knowledge. For example, a level can relate to a level of competence, level of expertise, proficiency level, competency level, extent of skill, and so on. Items can be associated with different levels. Example levels can be undergraduate and graduate school levels. At 204, system 100 performs item and level extraction to identify and label categories of the knowledge being assessed in questions or items in the cognitive test databanks 132. At 206, system 100 performs item and level extraction to identify and label categories of the skills being assessed in questions or items in the cognitive test databanks 132. That is, system 100 identifies and labels items and questions with categories of skill and knowledge. The knowledge databanks and skills databanks can be formed differently in some embodiments. For example, the knowledge databanks and skills databanks can be formed by examining the concepts and skills tested in different items. Items may assess just knowledge concepts such as an applicant's understanding of a specific concept, equation, definition, or idea. Items may separately assess just skills though an item may assess both knowledge and skills. At a high-level system 100 can build a knowledge databank that assess applicants' knowledge of the core concepts, principles, and frameworks of their field, while the skills databank might contain items that involve applying these areas of knowledge to real world or practical situations or situations where there is no clear textbook answer. Separately, skills items may test communication or problem solving skills that are not necessarily tied to specific concepts and their application, but can be measured distinctly from someone's knowledge in their field. Depending on the skills and knowledge that the user(s) demonstrate(s), different items can be extracted from the knowledge databanks and skills databanks to generate tests for the user(s) at 222.

At 208, system 100 trains or tunes models of the AI service 136 or other components and tools thereof, such as one or more LLMs 130 for knowledge and skills identification and extraction. The AI service 136 uses LLMs that are initially trained with labeled examples. These examples consist of items and questions that have been labeled and categorized into specific knowledge and skill categories. This foundational training helps LLM 130 understand the characteristics and nuances of different categories. The system continuously fine-tunes the LLMs using feedback and additional labeled examples. This iterative process ensures that the models improve over time, becoming more accurate in identifying and categorizing new items and questions. System 100 is configured to tune the one or more large language models for knowledge and skill classification and extraction using a dataset of labeled examples. Each labeled example has a corresponding classification label. System uses labeled examples to fine-tune the model for specific tasks. This step can involve training the model on a dataset where each input is paired with the correct output label. System 100 is configured for automatically categorizing new items with the tuned LLM. Once the model is fine-tuned, system 100 can categorize new data based on the patterns it has learned. System 100 is configured for transmitting alerts for categorizations and receiving feedback. The system 100 can send alerts based on the categorizations and receive feedback to further refine the model. System 100 is configured for outputting item and level categorizations generated by the LLM. The step involves generating and outputting the categorizations made by the models.

Fine-tuning LLMs with labeled examples is a process that involves adapting a pre-trained model to a specific task using a labeled dataset. This process can improve the model's performance on specialized tasks. Fine-tuning can involve supervised fine-tuning. This method uses labeled datasets specific to the target task, such as text classification or named entity recognition, to further train the model. Fine-tuning can involve reinforcement learning from human feedback. This method involves using human feedback to improve the model's performance on specific tasks. By using labeled examples, system 100 can leverage pre-existing data more effectively, even with limited labeled data, to achieve improvements in the models' performance

Once trained, the LLMs 130 can automatically categorize new items and questions. The system analyzes the content of each item or question, determining whether it pertains to knowledge or skills, and assigns appropriate categories based on categorization confidence scores corresponding to predefined criteria. For each categorization, AI service 136 generates a categorization confidence score indicating the likelihood that the assigned category is correct. If the confidence score for a particular label is high, the category is accepted; if it is low, the system raises an alert for human review via the reviewer interface 108. The system incorporates the feedback from human reviewers to further fine-tune the LLMs 130. This continuous learning process helps the models adapt to new types of items and questions, improving their categorization capabilities over time.

The categorization confidence scores generated by the one or more large language models can be numerical values that represent the level of certainty the one or more large language models have in its predictions or classifications for a given input data point.

The scores are helpful for understanding and interpreting the reliability of the model's outputs. Categorization confidence scores can be used to assess the likelihood that a given categorization is correct. The system 100 can generate categorization confidence scores by assigning numerical values to the model's predictions, indicating how confident the model is in its categorization.

System 100 can use different categories to label items and questions. In some embodiments, system 100 uses AI service 136 to tune or train the LLM(s) 130 to automatically characterize assessment questions based on whether they are knowledge-based or skills-based and what knowledge or skills they are assessing. System 100 can use different categories to label items and questions, and example categories include a knowledge-based category, and a skills-based category, along with different categories of different types of skill and knowledge.

System 100 can include varying degrees of categorizations. For example, in the context of medicine as an illustrative example, categorizations may include “anatomy”, “ethical principles”, “health systems knowledge”, “histology”, “neuroanatomy”, “tissue types”, or “cellular structures”. For skills-based competencies, categorizations may include “history taking”, “patient interaction”, and “decision making”. Categories could extend to any field to enable the system 100 to assess the relevant knowledge and skills competencies for each individual and recommend relevant resources.

System 100 automatically categorizes all new items according to the categories specified or identified during the fine-tuning of LLM(s) 130. System 100 can assign or label zero or more categories to the assessment questions or items. In some embodiments, if the system 100 assigns no categories to an item or question then an alert can be raised that the item or question could not be categorized automatically. The alert can be sent to a device (e.g. with a reviewer interface 108) along with information about the item or question for feedback. For example, the feedback could be a suggested category for the item or question so that system 100 can label the item or question with the category. In some embodiments, system 100 can assign a category to an item or question with an associated confidence score or value. If the confidence score or value is below a threshold value then the system 100 can send an alert to a device (e.g. with a reviewing interface 108) along with the proposed assigned category and information about the item or question for approval or feedback. In some embodiments, system 100 can suggest new categories for items or questions and then the system 100 can send the new categories to a device (e.g. with a reviewer interface 108) for feedback or approval (e.g. by a human operator). In some embodiments, system 100 can further fine-tune LLM(s) 130 based on provided feedback, such as labelled examples or new categories received at a reviewer interface 108. In some embodiments, items that cannot be accurately categorized (e.g. a proposed category having a confidence value below a threshold value) can be removed from the cognitive test databanks or assessment and item banks. Item and level categorizations (e.g. items or questions labeled with categories) can be used as part of computer adaptive testing (CAT) at 224 to more efficiently diagnose a user's skills or knowledge gaps.

System 100 can also use LLM(s) 130 to categorize development resources (e.g. from resource databank 134) and/or testing modules on the basis of the same skills and knowledge categories used in the LLM 130 for labeling and knowledge and skills identification and extraction. In some embodiments, system 100 can tune the same LLM 130 for both purposes of knowledge and skills extraction and development resource categorization to develop different trained LLM(s) 130. In some embodiments, system 100 can tune an LLM 130 for knowledge extraction/categorization and another LLM 130 for skills extraction/categorization. In some embodiments, system 100 can tune a separate LLM 130 for characterizing development resources. For example, development resources can include courses, clerkships, bridge programs, bootcamps, and smaller online modules such as online courses, reading materials, practice exercises and individual lessons. System 100 can categorize the resources as developing one or more skills or knowledge competencies by assigning labels (with categories) to the different resource components. For example, categories can be assigned based on descriptions, syllabi, learning objectives, sample content, and testimonials of the resources. In some embodiments, categories assigned by system 100 can intersect with the categories identified in the assessment or item categorization phase. In some embodiments, new or additional categories can be assigned by system 100, e.g. based on feedback received from reviewer interface 108.

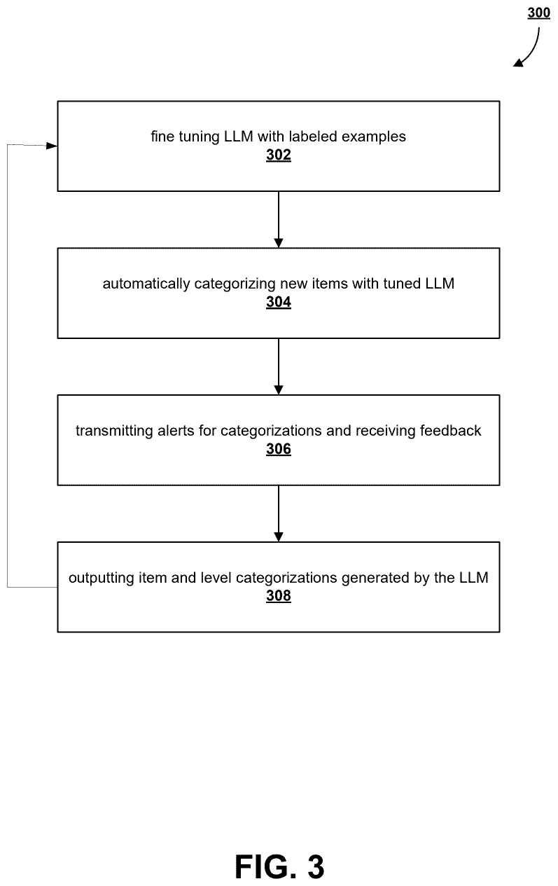

System 100 can identify additional competencies that have yet to be captured and automatically generate suggested test items to assess for these additional competencies. The additional competencies can have associated labels. Human operators can review and approve these suggested test items (e.g. using reviewer interface 108) for inclusion into an item or test bank, and input data may further include associated labels for the new items. Additional examples of generated items (and associated labels) could be used to further improve and fine-tune the system 100 at 220. Further details regarding tuning of LLM(s) 130 for knowledge and skills identification and extraction are provided in relation to FIG. 3.

At 210, system 100 generates customized LLM prompting for users. For example, in some embodiments, system 100 generates customized LLM prompting specific to each user. System 100 can prompt users for input data and extra information to improve the quality of its recommendation and generation of a curriculum. System 100 can continue prompting a user for additional information based on information provided by the user to clarify any uncertainties and improve understanding of the user's history, for example. System 100 can input the user's responses to the prompts into step 212 to help identify knowledge and skill gaps and corresponding resources for improvement. Users can query databases using natural language queries where an LLM can convert the natural language into code to analyze the databases. Users can query the database of development resources to find resources or a combination of resources to address particular skills or knowledge areas at the desired level of difficulty.

In some embodiments, at 232, system 100 can collect the user's history as input to improve the quality of its recommendations. For example, the user's history can include past courses the user has taken and the user's grades.

At 212, system 100 generates a conversation agent to identify knowledge and skills for development and, recommended resources. System 100 can include an LLM conversation agent to provide recommended resources based on (zero or more) inputs to system 100. In some embodiments, system 100 can take as input the user's results on items administered as part of the CAT. For example, the user's results can include questions and responses, such as full-text responses to open-ended questions, and skills or knowledge tags applied by system 100 at step 208. In some embodiments, system 100 can take as input the user's history. For example, the user's history can be uploaded to system 100 in some structured or unstructured format or collected as part of the user interactions in step 210. In some embodiments, system 100 can take as input development resources collected in steps 216 and 218 and tagged as part of step 220. A conversation agent can be referred to as a specialized chatbot, and is a type of artificial intelligence (AI) software designed to simulate a conversation with a user in natural language. An agent can engage with users in a conversational manner, helping with common inquiries and providing an optimized interface experience for the user. They can execute actions on behalf of humans, and dynamically invoke other agents or LLMs. A conversational agent is an advanced form of AI that aims to have human-like conversations. It is a dialogue system developed to understand and respond to natural language. Conversational agents work by processing user input, recognizing intent, understanding context, and generating human-like responses, for example.

System 100 can provide an initial recommendation to the user about what resources to use to address particular knowledge or skill gaps. If the user does not complete questions addressing some knowledge or skill categories, then system 100 can make estimations based on data of previous users with similar user histories as the user. If the user provides an incomplete history or does not provide any history, then system 100 can make estimations based on data of previous users who provided similar test responses. If system 100 is missing information, it can indicate a confidence level score for its recommendations and further prompt the user for required information to improve its recommendation confidence score. For example, system 100 may prompt the user for additional test items or additional user history information. If the user does not provide any history and does not complete any test items or questions, then system 100 will not provide any recommended resources. System 100 can still allow the user to query resources to address certain skill or knowledge areas and can recommend other resources that address complementary deficiencies at a similar level and resources that other users found helpful.

The LLM conversation agent can be used to allow the user to interact with system 100 to understand how the inputs and outputs are related. The user can interact with system 100 through the LLM conversation agent to get more details about how system 100 made decisions and recommendations. For example, the user can inquire for and receive more information about why particular resources were recommended by system 100, which skill or knowledge gaps were intended to be addressed by the recommended resources, and why system 100 identified those skill or knowledge gaps based on the user's test results and provided history. The user can also request further details about a specific resource. For example, the user can request details about how long a resource will take to complete, how useful the resource was to previous users, and how effective the resource is for addressing certain knowledge or skill gaps.

The LLM can allow recommendations made by system 100 to be communicated in a conversational way to the user that allows the user to make changes to the recommendations. The user can provide feedback to system 100 through the LLM conversation agent to alter the recommended resources and learning path. For example, the user can request additional resources to address knowledge gaps in a specific competency. The user can also provide feedback on how useful a resource was and system 100 can use the feedback to fine-tune the system. For example, user feedback about what resources to recommend, any changes the user makes to the recommended resources, and the effectiveness of the used resources at addressing particular knowledge or skill gaps can be used to fine-tune the system to improve effectiveness of recommendations to future users. In some embodiments, system 100 can administer test items to the user to assess whether skill or knowledge gaps still exist upon completion of a resource or after completing the resource for some time.

At 214, system 100 generates and delivers the prescribed curriculum. The prescribed curriculum/precision curriculum 138 can refer to a customized set of courses, lessons, and content tailored to meet the individual needs and goals of each user. System 100 can design the individualized prescribed curriculum based on a user's goals and measured skill or knowledge gaps. For example, the prescribed curriculum can include specific learning objectives, recommended materials and resources, and formative assessment methods to evaluate progress.

At 216 and 218, system 100 uses large curricular databases as resources from which components of a curriculum can be extracted and an individualized curriculum prescription can be created. For example, curriculum extraction can be done via learning management system (LMS) competency mapping. System 100 can extract courses, skills and knowledge from MOOC libraries in constructing a prescribed curriculum.

In some embodiments, at 220, system 100 will repeatedly tune, validate, or retrain the LLM using feedback and data received from different operations, such as LLM tuning (at 208), responses to LLM prompts (at 210), data received by a conversational agent (at 212), and data extracted from resources and curriculums (at 216 and 218).

At 222, system 100 creates validated tests (e.g. tests of cognitive ability) to assess users, such as testing for admissions eligibility to attend certain educational programs.

At 224, system 100 administers the tests for users as computer adaptive tests (CAT). In some embodiments, system 100 can administer the tests to a group of students or a single user. The tests can be administered as a single form or as fixed parallel forms. The tests can use both open-ended and close-ended formats of questions. The tests can be administered all at once or as separate tests.

At 226, system 100 collects and records each item response received from the testing at 224. For example, the system can receive item responses from users for the questions in the cognitive tests of ability. At 228 and 230, system 100 performs a knowledge and skill evaluation of the item responses, respectively, and item and level extraction on the item responses. System 100 receives item responses (from the CAT at 224) and saves the response data in association with the user. System 100 uses the response data to perform knowledge evaluation for items and levels for each user. System 100 uses the response data to perform skill evaluation for items and levels for each user. System 100 stores the knowledge evaluation data and skill evaluation data. At 232, system 100 can collect and store this response and evaluation data as a data record of the history of each user. For example, the user's history can include courses (in-person and online) that the user had taken before, associated performance metrics from courses, other resources that the user has used for studying, and opportunities that the user has been offered before. The user history can be combined through an application portal, such as College Board LandScape or a similar portal to identify gaps in the user's skills and knowledge when prescribing an individualized curriculum.

FIG. 3. shows a flow diagram of a process 300 for tuning one or more large language models (LLMs) for knowledge and skills identification and extraction.

The process 300 can be used by system 100 to characterize assessment questions based on whether they are knowledge or skills-based and what knowledge/skills they are assessing.

At 302, system 100 fine tunes an LLM 130 with labeled examples. For example, items can be labeled with one or more categories and the system 100 can train or fine-tune one or more LLMs based on the labeled items to provide example items and categories.

At 304, system 100 automatically categorizes new items according to the categories specified during fine-tuning of the LLM 130. The system 100 can assign zero or more categories to a new item. The system 100 can generate a confidence score for the assigned category. If the confidence score meets a threshold, then the category can be assigned to the item. If the confidence score does not meet a threshold, then a prompt or alert can be sent to reviewer interface 108 for feedback.

At 306, if the system 100 assigns no categories, then an alert can be raised that an item could not be categorized. The system 100 can determine that there are no categories if none of the categories defined in system 100 have an associated confidence score that meets a threshold.

The alert and data associated with the item can be transmitted to the reviewer interface 108 to review and label the category for the item. The reviewer interface 108 can provide input or feedback data for the label, for example. The system 100 can also suggest new categories that would then be approved by a human via reviewer interface 108. The system 100 could then be further fine-tuned based on additional human-labeled examples or new categories suggested and approved by input from reviewer interface 108. In some embodiments, items that cannot be accurately categorized can be removed from the assessments or item banks.

At 308, system 100 outputs and/or stores item and level categorizations generated by the LLM(s) 130. Item and level categorizations can be used as part of the CAT to more efficiently diagnose skills/knowledge gaps. In some embodiments, system 100 outputs data about items or resources categorized as developing one or more skills/knowledge competencies.

In addition to items, the system 100 could also be used to categorize development resources and/or modules on the basis of the same skills and knowledge categories. This system 100 can use the same LLM fine-tuned as set out above, or the system 100 could fine-tune a separate LLM 130 for different types of development resources/modules, or additional LLMs 130.

The system 100 could also identify additional competencies that are not already captured. System 100 could automatically generate suggested test items to assess for these competencies. The items would be reviewed and approved by reviewer interface 108 for inclusion in the item/test bank. Additional examples of generated items could be used to further improve and fine-tune the LLMs 130 of system 100.

Accordingly, the process 300 can continuously and iteratively categorize items or resources, prompt for feedback if categories cannot be automatically assigned or labeled, and fine tune LLMs 130 based on the updated categorizations and items.

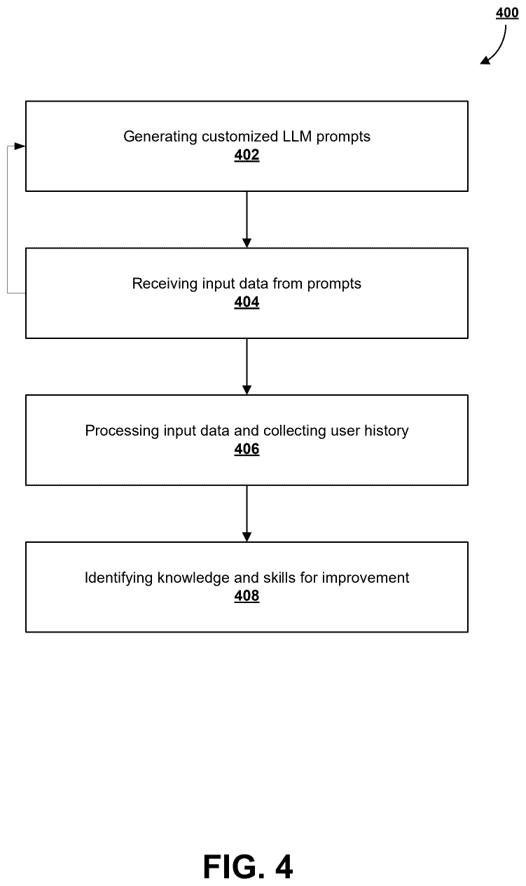

FIG. 4. shows a flow diagram of a process 400 for customized LLM prompting for each user.

System 100 can use different prompts to collect additional information. For example, system 100 can prompt the user to collect an initial user history with prompts such “Provide a list of courses taken” and further probe the user for more information with prompts such as “What grade did you receive in course X?” The system 100 may prompt the user to self-identify areas that they found difficult in past experiences with prompts such as “What did you find were the most difficult aspects in course X?” The system 100 could also prompt for which areas the student found easier. The system 100 could prompt the user to identify what their goals are in order to improve the recommendations generated by system 100 to help the user address the relevant gaps using prompts such as “What are your career goals?” The system 100 can also prompt the user to identify other experiences they've participated in, which could vary depending on the user's goals. For example, the system 100 may prompt with “Have you contributed to any experimental research?”.

At 404, the system 100 receives input data in response to the prompts. For example, the system 100 can receive input data from applicant interface 102 in response to providing prompts at the applicant interface 102.

At 404, the system 100 can prompt at an interface of a device for input or additional information to improve the quality of the recommendations by the LLM(s) 130 at 402. For example, system 100 can provide prompts at applicant interface 102 for input data to train or tune the LLM(s) 130 or analyze data, such as user history records stored in memory 114. System 100 can generate different trained LLMs 130 for different users or applications, for example. System 100 can implement different training processes and different training data sets. For example, system 100 can use data provided by applicants including user history as inputs for supervised fine-tuning of LLMs 130 with associated outcome data that may include successfully completed courses or assessments at a later time or feedback from applicants that suggested courses or resources were or were not helpful. System 100 may also use reinforcement learning from human feedback to continually adjust one or more LLMs 130 output based on applicant feedback on recommendations. This feedback can take the form of binary or numeric ratings of individual recommendations or direct comparison of recommendations.

The system 100 can continue prompting (at 402) to receive additional information (at 404) based on information previously provided by the user. For example, the system 100 can continue prompting (at 402) to clarify any uncertainties and improve the system's 100 understanding of the user's history. For example, system 100 may prompt the user to reconcile any uncertainties or clarify any inconsistencies. For example, based on user test responses and/or user histories provided, the system 100 may find inconsistencies in what a user self-identified as difficulties and gaps identified through testing. The system 100 may try to reconcile these inconsistencies by prompting the user to elaborate with “Could you elaborate on which areas of course X you found difficult and why?” Or the system may prompt the user to elaborate on some of their test responses: “Can you explain why you answered this question in the way that you did?” to more precisely diagnose any knowledge/skills gaps. User histories such as past courses taken and grades can be provided to the system 100 and/or stored by the system 100. In some embodiments, the system 100 can prompt users (e.g. at applicant interface 102) for input information to improve the quality of the recommendations and prescribed curriculum.

At 406, the system 100 processes the input data. For example, system 100 can collect data and store the data as part of the user history record.

As another example, the system 100 can process the input data to generate database queries. Users (e.g. using applicant interface 102) can provide input data to query databases using natural language where an LLM can convert natural language input into code (e.g. database queries) to analyze the databases. Users can query the database of development resources to find resources or a combination of resources to address particular skills or knowledge areas at the desired level. The system 100 can return results of the queries (e.g. at applicant interface 102). The database can receive different types of queries and provide different types of output. For example, the user could provide natural language queries to the interface 102 such as “What resources can I use to develop my skills in X?”, “How effective is resource X for addressing concept Y?”, and “How long does it typically take to develop competency in skill X?”. The system 100 can convert the queries into code (such as SQL) that would be run against a database containing information on resources and past students' interactions with the system 100 using specific resources and completing test items.

The LLM 130 and/or AI service 136 in system 100 converts text queries into code through a process involving natural language processing and machine learning. Initially, the LLM is trained on a vast dataset that includes both natural language and code, sourced from publicly available code repositories, documentation, and examples from various programming languages. This foundational training helps the model understand the relationship between natural language commands and their corresponding code structures. When a user inputs a text query, the LLM processes the natural language to comprehend the intent behind the query, parsing it to identify key components and the desired outcome. Using its trained knowledge, the LLM maps the parsed query to relevant code constructs, identifying the appropriate programming elements, libraries, and functions needed to fulfill the query. The model then generates the code by assembling these components into a coherent and executable snippet, ensuring it adheres to the syntax and conventions of the specified programming language. The generated code is validated to check for errors and correctness, and if it does not meet the user's expectations, the system prompts for additional information or clarification. This feedback loop is crucial for further fine-tuning the model, enhancing its accuracy and efficiency in future code generation. The system 100 could output results of this query using natural language, images (including graphs), and/or tables, based on what the system 100 deems to be the most appropriate way to respond to the query. The user would be able to specify an output format as well or ask for additional information or ways of representing data queried.

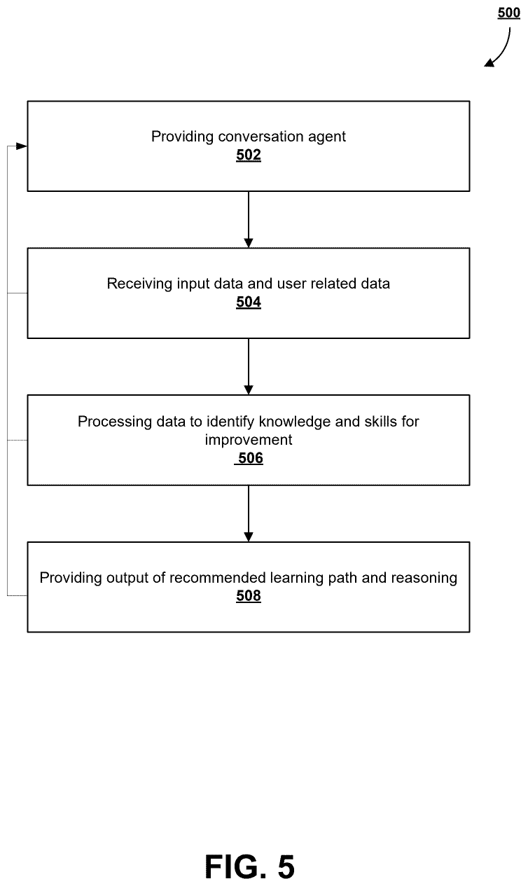

At 408, the system 100 can use the input data to help identify knowledge and skills gaps and resources for improvement. The system 100 can use the input data from the user's responses for training the LLMs at 208 and/or for the conversation agent at 212 to help identify knowledge and skills gaps and resources for improvement. The conversation agent may utilize process 500 as illustrated in FIG. 5.

FIG. 5. shows a flow diagram of a process 500 for a conversation agent to identify knowledge and skills for development, and identify recommended resources.

At 502, system 100 provides a conversation agent at an interface, such as applicant interface 102. For example, the conversation agent can be a bot or virtual agent that communicates with a user (e.g. at an interface) using natural language to receive input, provide responses, and initiate tasks. The conversation agent can simulate a conversation with a user in natural language using a messaging application, for example. The conversation agent can be a dialogue system that conducts natural language processing and then responds to queries or provides output based on the received input.

At 504, the system 100 receives input data. The system 100 can also receive metadata or user related data from the agent interface or from datastores or other systems. For example, the system 100 can take the following as inputs from the other parts of the system: (i) student results on items administered as part of the CAT; (ii) user history records; (iii) development resources. The student results on items administered as part of the CAT can include questions and responses. The responses may be full text responses if using open-ended questions in the CAT, for example. The input can also be skills and/or knowledge labels or tags applied at 208, for example. The user histories can be uploaded to the system 100 in some structured or unstructured format. The user histories can be collected as part of the user interactions with system 100 from prompts at 210. The development resources can be collected at operations 216 and 218 and tagged (or labeled) as part of operation 220.

At 506, the system 100 processes data (including input received at the conversation agent) to identify knowledge and skills for development or improvement. The system 100 categorizes user responses to test items, identifying areas where the user demonstrates proficiency and areas where there are gaps. The system may utilize LLMs to recognize patterns correlating the users to the identified knowledge and skills for development to fine-tune the conversation agent for future prompt and recommendation generations.

At 508, the system 100 can generate output data, such as recommendations for improving or developing the identified knowledge and skills, or a learning path. The recommendations could lead to a prescribed curriculum for each student. This curriculum includes specific courses, lessons, and content designed to meet the individual needs and goals of the student, focusing on areas that require improvement.

The system 100 can also generate, as output via the LLM, reasonings for its recommendations. The system 100 can utilize explanation models to generate reasonings for its recommendations. These models are trained to interpret the decision-making process of the LLMs and translate it into understandable natural language. The system 100 may also provide contextual information to support its recommendations. For example, it may explain that a particular resource was recommended because it has been effective for other students with similar gaps.

The LLM conversation agent could be used to allow the user to interact with the system 100 to understand how the inputs and outputs are related. The LLM conversation agent allows the recommendations to be communicated in a more conversational way that allows the user to make changes. This provides an advantage of providing more helpful and understandable information to the user about the decision or recommendation. Providing the information in a conversational way avoids having to provide all technical details of the LLMs and the associated technical recommendation process which may not be feasible given the constraints (e.g. limited size) of a display device or user interface, and the (limited) technical capacity of the end user. Further, the technical details of the LLMs may not be comprehendible to the user. Providing the information in a conversational way avoids having to provide detailed technical information at the machine learning level or LLM level but still provides helpful information to the user about the recommendation. In some embodiments, after the system 100 provides recommendations for specific knowledge/skill development (or a more complete learning path), users can query the system 100 for specific information about parts of the system's recommendation. For example, if a user queries “Why did you recommend that I complete resource X?” the system 100 can evaluate the local interpretability of the machine learning system to determine which inputs had the largest impact on the model's particular decision here. Inputs affecting the decision could include the user's test item responses or elements of the user's history. The system 100 can then return high-level explanations such as “I recommended resource X because you answered the following questions incorrectly, indicating a lack of understanding of concept Y”. The system 100 can also query the database of past student results to calculate simple statistics and provide additional context such as “X % of students who answered similar questions incorrectly successfully demonstrated these concepts after completing resource Y”.

The system 100 can provide an initial recommendation to the user about what resources to use to address particular knowledge/skills gaps using the conversation agent. For example, if the user does not complete questions (e.g. of a CAT) addressing knowledge/skills categories or if the user does not complete any items, then the system 100 can make estimations or recommendations based on patterns in previous users with similar user histories.

If the user does not provide any user history (or provides an incomplete history), then the system 100 can make estimations based on patterns established by previous users with similar test responses. In some embodiments, if the system 100 is missing any information it can request additional input using a conversation agent. In some embodiments, system 100 can generate and indicate a confidence level for its recommendations. The system 100 can further prompt the user for required information to improve its recommendation confidence, for example. The requests could be for additional test items or additional user history information, for example.

In some embodiments, if the user does not provide any history and does not complete any test items, then the system 100 will not provide any recommended resources, or a default set of recommendations based on general information about the user. The system 100 may then alert the user interface for human intervention.

In some embodiments, the system 100 can allow the user to query resources to address certain skills or knowledge areas. The system 100 can recommend other resources that address complementary deficiencies at a similar level and resources that other users found helpful.

The user can further interact with the system 100 (via a conversation agent) as a conversation dialogue to get more details about how decisions from the system 100 were reached or made. For instance, the user can get more information about why particular resources were recommended, which skills/knowledge gaps they were meant to address, and why the system identified these gaps based on the student's test results and provided histories. This information can be presented to the user as natural language. For example, the LLM can translate local machine learning interpretability as to how particular decisions were made into human interpretable language that are relayed to the user. In some cases, the system 100 may extract additional information or statistics that could be presented in a table or graph to illustrate the effectiveness of resources for previous users of the system 100.

The user can request further details such as how long a resource will take to complete, how useful the resource was to previous users, and how effective resources were for addressing certain knowledge/skills gaps. The user can provide feedback to the system 100 to alter the recommended resources and learning path. For instance, the user can request additional resources to address knowledge gaps in some competency.

User feedback about what resources to recommend (i.e., changes a user makes to the recommended resources) can then be used by system 100 to fine-tune the LLM(s) at 220. Users can also provide feedback on how useful a resource was so that system 100 can further fine-tune the LLM(s). Test items can be administered to assess whether skills or knowledge gaps exist after completing a resource or some time later.

Resources used by users and the effectiveness of those resources at addressing particular knowledge/skills gaps can be used by system 100 to further fine-tune the LLM(s) or other models (used for recommendations) as to what resources to recommend to future users. For example, models can be tuned based on which students took which courses and found them helpful to address certain gaps.

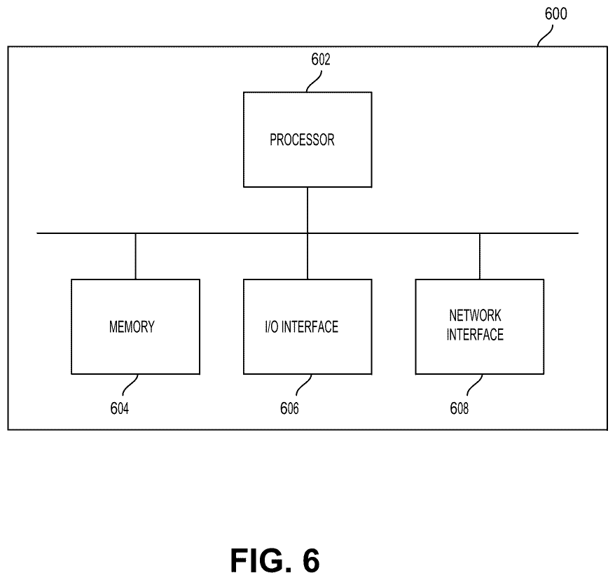

FIG. 6 is a schematic diagram of a computing device 600, exemplary of an embodiment. As depicted, computing device 600 includes at least one processor 602, memory 604, at least one I/O interface 606, and at least one network interface 608.

For simplicity only one computing device 600 is shown but system may include more computing devices 600 operable by users to access remote network resources and exchange data. The computing devices 600 may be the same or different types of devices. The computing device 600 includes at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

Each processor 602 may be, for example, a microprocessor or microcontroller, a digital signal processing (DSP) processor, an integrated circuit, a field programmable gate array (FPGA), a reconfigurable processor, a programmable read-only memory (PROM), or any combination thereof.

Memory 604 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 606 enables computing device 600 to interconnect with one or more input devices, such as a keyboard, mouse, camera, touch screen and a microphone, or with one or more output devices such as a display screen and a speaker.

Each network interface 608 enables computing device 600 to communicate with other components, to exchange data with other components, to access and connect to network resources, to serve applications, and perform other computing applications by connecting to a network (or multiple networks) capable of carrying data including the Internet, Ethernet, telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing device 600 is operable to register and authenticate users (using a login, unique identifier, and password for example) prior to providing access to applications, a local network, network resources, other networks and network security devices. Computing devices 600 may serve one user or multiple users.

Embodiments may provide particular improvement in fair admissions to educational programs.

Differences exist in the mean performance of standardized tests between racial, cultural and socioeconomic groups. For example, this is dramatically shown by results of SAT (Sackett and Shen, 2010), ACT (Sackett and Shen, 2010), GRE (Roth et al, 2001), GMAT (Camara and Schmidt, 1999), MCAT (AAMC Data Warehouse, 2012), and LSAT (Camara and Schmidt, 1999). These differences in mean test score are not driven by group differences in cognitive ability but by group differences in achievement and preparedness.

Although an educational program may prefer cognitive ability over preparedness as a fair assessment criteria. Post-secondary educational programs are often forced to continue to rely on achievement-based selection tools because the cost of selecting the most able but frequently unprepared students would be prohibitively expensive.

The scalable and affordable process of testing for broad-scale cognitive ability proposed herein would aid in up-levelling able but unprepared students. The assessment of ability independent from knowledge would enable decision makers to more fairly distribute educational opportunities. Further, there are technical challenges for providing education services using distributed computing components. Embodiments described herein provide an improved distributed system for precision education.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices.

It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may improve test delivery, improve machine learning, and provide efficient data storage.

The following discussion provides many example embodiments. Although each embodiment represents a single combination of inventive elements, other examples may include all possible combinations of the disclosed elements. Thus, if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A computer system for cognitive tests for scalable precision education for a user, the system comprising:
a memory storing one or more large language models, user history records, and one or more databanks of items;
a computer hardware processor coupled with computer memory, a non-transitory computer readable storage medium, and an applicant interface residing on an electronic device, the computer processor configured to:
tune the one or more large language models for knowledge and skill classification and extraction using a dataset of labeled examples, wherein each labeled example has a corresponding classification label;
classify and extract skill items and knowledge items from the one or more databanks of items based on categorization confidence scores generated by the tuned one or more large language models;
administer a cognitive test, at the applicant interface residing on the electronic device, using the skill items and knowledge items, the cognitive test producing a set of resulting scores indicating a user evaluation in skill and knowledge, respectively;
generate, by a conversation agent enabled by the one or more large language models, a customized prompting based on the user history records and the user evaluation in skill and knowledge;
receive, by the conversation agent, user response data, the conversation agent classifying the user response data to identify recommended skills and knowledge for development; and
generate a prescribed curriculum customized for the user based at least on the recommended skills and knowledge for development, and transmit the prescribed curriculum for the user, the prescribed curriculum being a reduced data size for efficient storage and transmission while providing effective skills and knowledge development for the user.

2. The system of claim 1, wherein the conversation agent is fine-tuned using the recommended skills and knowledge for development, the conversation agent fine-tuned to generate a future customized prompting based on a pattern recognized between the user and the recommended skills and knowledge for development.

3. The system of claim 1, wherein the one or more large language models query development resource databases using query codes converted from natural language corresponding to the recommended skills and knowledge for development, the one or more large language models receiving a development resource or a combination of development resources to generate the prescribed curriculum for the user.

4. The system of claim 1, wherein the prescribed curriculum comprises a selection of: online courses, reading materials, practice exercises, and individual lessons.

5. The system of claim 1 wherein the one or more databanks of items comprise labeled items with assigned categories and unlabeled items, wherein the processor tunes the one or more large language models with the labeled items with assigned categories, automatically categorizes the unlabeled items using the tuned one or more large language models, and outputs item categorizations generated by the tuned one or more large language models.

6. The system of claim 1, wherein if the categorization confidence scores are below a predetermined threshold, the processor generates an alert requesting a human review.

7. The system of claim 6, wherein the processor transmits the skill items and knowledge items to a reviewer interface for manual labeling and feedback, and tunes the one or more large language models using the feedback.

8. The system of claim 1, wherein the processor automatically assigns one or more categories to each item of at least a portion of the items using the tuned one or more large language models, wherein the process generates an alert when an item cannot be automatically categorized.

9. The system of claim 1 wherein the processor automatically categorizes learning resources using the one or more large language models.

10. The system of claim 1 wherein the processor provides the conversation agent to provide a recommendation to a user about resources to address particular knowledge or skills for development and justifications on how the recommendation was generated.

11. The system of claim 1 wherein the processor tunes the one or more large language models to categorize at least a portion of items based on what knowledge or skill a respective item is assessing.

12. The system of claim 1 further comprising a client web application with a curriculum interface to provide the prescribed curriculum.

13. The system of claim 1 further comprising a client web application with a reviewer interface to display alerts for categorizations and receive feedback, wherein the processor tunes the one or more large language models based on the feedback.

14. The system of claim 1 further comprising a client web application with an applicant interface to provide a computer adaptive test to collect response data for each user, wherein the memory comprises a user history record storing the collected response data and corresponding evaluation data.

15. The system of claim 1 further comprising a client web application with a rater interface that provides response data for a computer adaptive test and collects corresponding evaluation data for the response data for the computer adaptive test.

16. The system of claim 1 wherein the computer processor is configured to tune the one or more large language models for knowledge and skill classification and extraction using a dataset of labeled knowledge examples and another data set of skill examples.

17. The system of claim 1 wherein the categorization confidence scores generated by the one or more large language models comprise numerical values that represent the level of certainty the one or more large language models have in its predictions or classifications for a given input data point.

18. The system of claim 1 wherein the prescribed curriculum is specific to a user and different from prescribed curriculums for other users, wherein the prescribed curriculum is an education plan, a set of courses and educational content for the user.

19. A computer method for cognitive tests for scalable precision education, the method comprising:
tuning the one or more large language models for knowledge and skill classification and extraction using labeled examples;
classifying and extracting skill items and knowledge items from the one or more databanks of items based on categorization confidence scores generated by the one or more large language models;
administering a cognitive test, at the applicant interface, using the skill items and knowledge items, the cognitive test producing a set of resulting scores indicating a user evaluation in skill and knowledge, respectively;
generating, by a conversation agent enabled by the one or more large language models, a customized prompting based on the user history records and the user evaluation in skill and knowledge;
receiving, by the conversation agent, user response data, the conversation agent classifying the user response data to identify recommended skills and knowledge for development; and
generating and outputting at the applicant interface, a prescribed curriculum for the user based at least on the recommended skills and knowledge for development.

20. A non-transitory computer readable medium storing computer interpretable instructions, which when executed by a processor, cause the processor to execute a method for cognitive tests for scalable precision education, the method comprising:
tuning the one or more large language models for knowledge and skill classification and extraction using labeled examples;
classifying and extracting skill items and knowledge items from the one or more databanks of items based on categorization confidence scores generated by the one or more large language models;
administering a cognitive test, at the applicant interface, using the skill items and knowledge items, the cognitive test producing a set of resulting scores indicating a user evaluation in skill and knowledge, respectively;
generating, by a conversation agent enabled by the one or more large language models, a customized prompting based on the user history records and the user evaluation in skill and knowledge;
receiving, by the conversation agent, user response data, the conversation agent classifying the user response data to identify recommended skills and knowledge for development; and
generating and outputting at the applicant interface, a prescribed curriculum for the user based at least on the recommended skills and knowledge for development.
